(19) United States
(12) Patent Application Publication
(10) Pub. No.: US 2014/0253995 A1
(43) Pub. Date: Sep. 11, 2014

(54) INJECTION MOLD, OPTICAL COMPONENT, OPTICAL SCANNING DEVICE, AND IMAGE FORMING APPARATUS

(71) Applicants: Takamichi OHHASHI, Kanagawa (JP); Eiichi HAYASHI, Iwate (JP); Yusuke OHTA, Kanagawa (JP)

(72) Inventors: Takamichi OHHASHI, Kanagawa (JP); Eiichi HAYASHI, Iwate (JP); Yusuke OHTA, Kanagawa (JP)

(73) Assignee: RICOH COMPANY, LTD., Tokyo (JP)

(21) Appl. No.: 14/188,788

(22) Filed: Feb. 25, 2014

(30) Foreign Application Priority Data
Mar. 7, 2013 (JP) 2013-045063

(51) Int. Cl. G02B 26/12; B29C 45/00; B29C 45/26; G02B 13/00

(52) U.S. Cl. CPC G02B 26/125; G02B 13/0005; B29C 45/0025; B29C 45/26
USPC 359/206.1; 359/662; 425/577

(57) ABSTRACT

There is provided an injection mold for molding an optical component including an optical surface, a non-optical surface separated from the optical surface, and a rib provided to an edge portion of the optical surface, and longer in a direction parallel to the optical surface than in a direction perpendicular to the optical surface. The mold includes a transfer piece including a transfer surface that molds the optical surface and a movable cavity piece including a non-transfer surface that molds at least a portion of the non-optical surface. The transfer surface and the non-transfer surface define a cavity to be filled with resin. The movable cavity piece is moved away from the resin during a process of cooling the resin. At least a portion of the non-transfer surface is located closer to the rib than a boundary between the transfer surface and the rib.

### CROSS-REFERENCE TO RELATED APPLICATION

This patent application is based on and claims priority pursuant to 35 U.S.C. §119 to Japanese Patent Application No. 2013-045063, filed on Mar. 7, 2013, in the Japan Patent Office, the entire disclosure of which is hereby incorporated by reference herein.

### BACKGROUND

1. Technical Field

The present invention relates to an injection mold for use in injection molding of a resin, an optical component molded in the injection mold, an optical scanning device including the optical component, and an image forming apparatus including the optical scanning device.

2. Related Art

Some optical components of an optical scanning system in an electronic apparatus equipped with an optical scanning device such as a digital laser copier or a laser printer or facsimile machine, optical components of an optical system in an optical device such as a video camera, and optical components such as an optical disc are molded from a resin material.

For example, optical components such as lenses, prisms, and mirrors are required to be highly accurate in optical surface shape and internal birefringence. Therefore, most such optical components have been made of glass in the past. With a demand for a reduction in product cost, however, glass optical elements have increasingly been replaced by plastic ones.

An optical component manufactured by resin molding (hereinafter referred to as a resin-molded optical component) is mass-producible at low cost, even if the optical component has a special shape, by inserting a resin base material into a cavity of a mold formed to conform to the shape of an intended molded product or by injecting a fused resin into the cavity.

The resin-molded optical component is formed in shapes that vary depending on the intended use. For example, the resin-molded optical component may be formed in a so-called uneven thickness shape (i.e., a shape uneven in thickness) including a thick portion and a thin portion, which needs to be highly accurately transferred from a mold.

Particularly, an fθ lens, which is as a resin-molded optical component employed in a laser printer or the like, is often designed to have a complicated aspheric mirror surface shape to attain multiple functions with minimum necessary optical components.

In the manufacture of the resin-molded optical component having such a complicated shape, it is desirable that the pressure and temperature of the fused resin injected in the cavity of the mold are kept uniform in the cavity during a cooling solidification process of the resin to accurately mold the resin into a desired shape.

In the manufacture of the resin-molded optical component having a complicated shape, however, the cooling solidification speed varies depending on the location. Therefore, internal stress generated in the cooling process may cause adhesion of a molded product to the mold or poor release of the molded product from the mold during removal of the molded product from the mold, and also may cause deformation (e.g., warping) of the molded product after the removal of the molded product from the mold. Particularly, the resin-molded optical component tends to suffer from birefringence due to internal strain.

To reduce the internal stress generated in the cooling process of injection molding, it is desirable to keep the injection pressure low during the injection of the resin into the mold. In lower-pressure injection molding, however, the resin contraction amount during the cooling process is increased owing to a reduction in the amount of the injected resin relative to the volume of the cavity. That is, the lower-pressure injection molding tends to cause sink marks (i.e., surface depressions) in the resin-molded product, reducing the accuracy of transfer of the mold shape.

To address the issue of sink marks occurring in the low-pressure injection molding, air pressure may be supplied to non-transfer surfaces of the resin through vents in the mold to generate a pressure difference between the non-transfer surfaces and transfer surfaces of the resin and thereby guide the sink marks toward the non-transfer surfaces.

Alternatively, some of inserts forming the cavity of the mold (hereinafter referred to as movable inserts) may be slid during the molding process to separate the non-transfer surfaces of the resin from the movable inserts. According to this technique, internal pressure of the resin is generated in the cavity by the injection of the resin into the cavity, and the movable inserts are moved to separate from the non-transfer surfaces of the resin to forcibly form air gaps therebetween while maintaining appropriate pressure for keeping the transfer surfaces of the resin in close contact with the cavity, thereby guiding the sink marks toward the non-transfer surfaces.

Still alternatively, air pressure may be supplied to a given position on a rib provided to the resin-molded product and the intersection of a transfer surface and the rib, to thereby guide the sink marks toward a non-transfer surface.

According to the above-described techniques, however, the air pressure causes internal strain in the resin, increasing the possibility of deformation of the resin-molded product. A resin-molded optical component subjected to internal strain suffers from significant birefringence.

For example, if the above-described technique using the movable inserts is employed to mold a resin-molded optical component having a thickness (i.e., thickness in the direction of a beam incident on an optical surface or a transfer surface thereof) less than the width thereof, the resin contracts faster on transfer surfaces than on non-transfer surfaces, and thus the sink marks tend to appear on the transfer surfaces.

Since the resin-molded optical component having such a shape usually has ribs for protecting the transfer surfaces, the thickness of the resin-molded optical component is increased at the intersections of the transfer surfaces and the ribs. In the thus-shaped resin-molded optical component, therefore, the sink marks are likely to extend over the optical surfaces from the intersections.

### SUMMARY

The present invention provides an improved injection mold for molding an optical component which includes an optical surface, a non-optical surface separated from the optical surface, and a rib provided to an edge portion of the optical surface, and which is longer in a direction parallel to the optical surface than in a direction perpendicular to the optical surface. The injection mold includes, in one example, a transfer piece including a transfer surface configured to mold the optical surface and a movable cavity piece including a non-transfer surface configured to mold at least a portion of the non-optical surface. The transfer surface and the non-transfer surface define a cavity to be filled with resin. The movable cavity piece is moved away from the resin during a process of cooling the resin filling the cavity. At least a portion of the non-transfer surface is located closer to the rib than a boundary between the transfer surface and the rib.

The present invention further provides an improved optical component that is molded in the injection mold, an improved optical scanning device including the optical component, and an improved image forming apparatus including the optical scanning device.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a cross-sectional view in the lateral direction of an injection mold according to an embodiment of the present invention;

FIG. 2 is a perspective view of an optical component molded in the injection mold in FIG. 1;

FIG. 3 is a side view in the longitudinal direction of the optical component in FIG. 2;

FIG. 4 is a rear view of the optical component in FIG. 2;

FIG. 5 is a partial side view in the longitudinal direction of the optical component in FIG. 2, enlarging a portion of the optical component near an attachment portion of the optical component;

FIG. 6 is a cross-sectional view in the lateral direction of an injection mold according to another embodiment of the present invention;

FIG. 7 is a perspective view of an optical component molded in the injection mold in FIG. 6;

FIG. 8 is a side view in the longitudinal direction of the optical component in FIG. 7;

FIG. 9 is a rear view of the optical component in FIG. 7;

FIG. 10 is a partial side view in the longitudinal direction of the optical component in FIG. 7, enlarging a portion of the optical component near an attachment portion of the optical component; and

FIG. 11 is a top view of an optical scanning device according to an embodiment of the present invention.

### DETAILED DESCRIPTION

In describing the embodiments illustrated in the drawings, specific terminology is adopted for the purpose of clarity. However, the disclosure of the present invention is not intended to be limited to the specific terminology so used, and it is to be understood that substitutions for each specific element can include any technical equivalents that have the same function, operate in a similar manner, and achieve a similar result.

Referring now to the drawings, wherein like reference numerals designate identical or corresponding parts throughout the several views, description will be given of an injection mold, an optical component, an optical scanning device, and an image forming apparatus according to embodiments of the present invention.

An injection mold according to an embodiment of the present invention will first be described. Description will be given of an example in which the injection mold according to the present embodiment is applied to resin molding of an optical component.

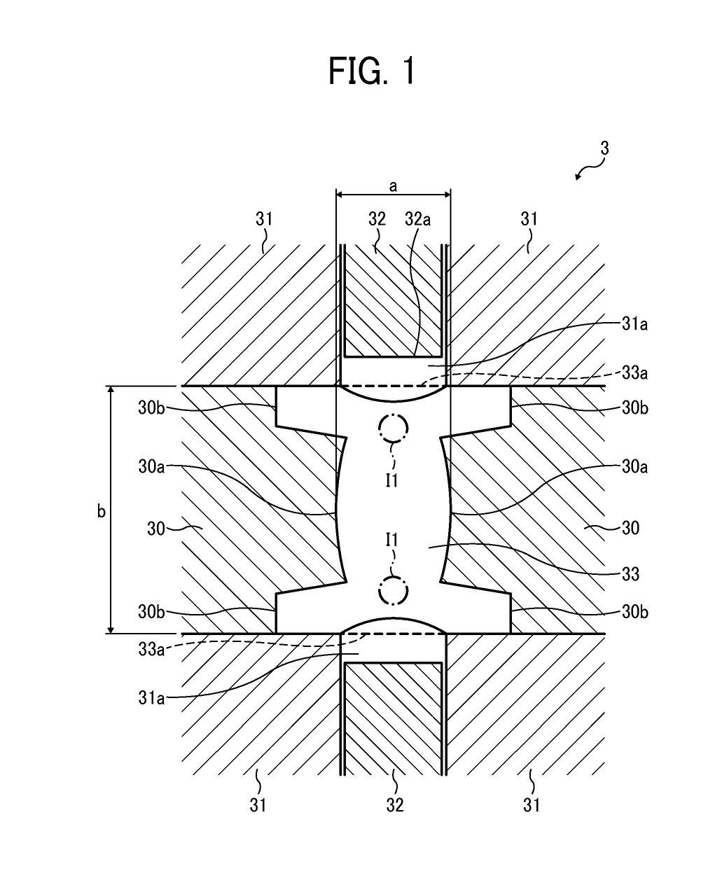

The configuration of the injection mold according to the present embodiment will now be described. FIG. 1 is a cross-sectional view in the lateral direction of the injection mold according to the present embodiment. As illustrated in FIG. 1, an injection mold 3 includes transfer pieces 30, slide pieces 31, and movable cavity pieces 32.

In the injection mold 3, the transfer pieces 30, the slide pieces 31, and the movable cavity pieces 32 define a cavity 33 to be filled with a resin serving as a material of the optical component.

Each of the transfer pieces 30 is a fixed piece having a transfer surface 30a for molding an optical surface of the optical component and rib forming portions 30b for forming ribs of the optical component.

Each of the slide pieces 31 is a mold for molding a portion of a non-optical side surface of the optical component. The slide piece 31 includes a hole 31a for inserting and withdrawing the corresponding movable cavity piece 32 in a molding process of the optical component.

Each of the movable cavity pieces 32 has a non-transfer surface 32a for molding at least portions of non-optical surfaces of the optical component. Before the resin is injected into the cavity 33, the non-transfer surface 32a of the movable cavity piece 32 is located at a non-transfer surface stop position 33a in the cavity 33.

During a cooling process of the resin injected in the cavity 33 defined by the transfer surfaces 30a and the non-transfer surfaces 32a, the movable cavity pieces 32 are moved away from the resin. That is, the movable cavity pieces 32 is moved in a direction different from the pressing direction of the transfer surfaces 30a for pressing the resin.

Herein, the optical component molded in the injection mold 3 has a thickness a in the beam incidence direction and a width b having a relationship a<b.

Further, at least portions of longitudinal side surfaces of the optical component formed by the non-transfer surface 32a are located closer to the rib formed by the rib forming portions 30b than the boundary between the optical surfaces formed by the transfer surfaces 30a and the rib. In other words, at least portions of the non-optical surfaces are formed in a region including the intersection of the rib and the optical surfaces by the non-transfer surface 32a of the movable cavity piece 32.

In FIG. 1, the position corresponding to the intersection of the rib and the optical surfaces is indicated by a dash-dotted circle I1. Since the thickness of the optical component is maximized at the position of the circle I1, the position of the circle I1 corresponds to the center of resin contraction when the resin injected in the cavity 33 is cooled and contracted.

Description will now be given of a procedure of resin-molding the optical component in the injection mold 3.

The resin is first injected into the cavity 33 at low pressure, with the movable cavity pieces 32 placed at the non-transfer surface stop positions 33a in the cavity 33. As the resin is cooled and contracted immediately after the injection, the pressure in the cavity 33 is reduced.

Then, before the pressure of the resin becomes negative, each of the movable cavity pieces 32 is retracted in a direction of separating from the corresponding non-transfer surface stop position 33a, as illustrated in FIG. 1. Thereby, the resin injected in the cavity 33 separates from the non-transfer surfaces 32a.

That is, in the injection mold 3, the movable cavity pieces 32 having the non-transfer surfaces 32a for forming the non-optical surfaces of the optical component are moved in a direction of separating from the center of the cavity 33 during the cooling and contraction of the resin occurring after the injection of the resin.

Thereafter, the cooling and contraction of the resin continues around the circles I1, as described above. Therefore, the contraction of the resin does not affect the optical surfaces formed by the transfer surfaces 30a.

That is, the location of resin contraction in the injection mold 3 is limited to the non-optical surfaces by the movable cavity pieces 32, thereby keeping the center of resin contraction away from the optical surfaces and regions affecting the optical surfaces. According to the injection mold 3, therefore, the shape thereof is highly accurately transferred to the molded product at low cost.

Description will now be given of an optical component according to an embodiment of the present invention. The optical component according to the present embodiment is molded in the above-described injection mold 3.

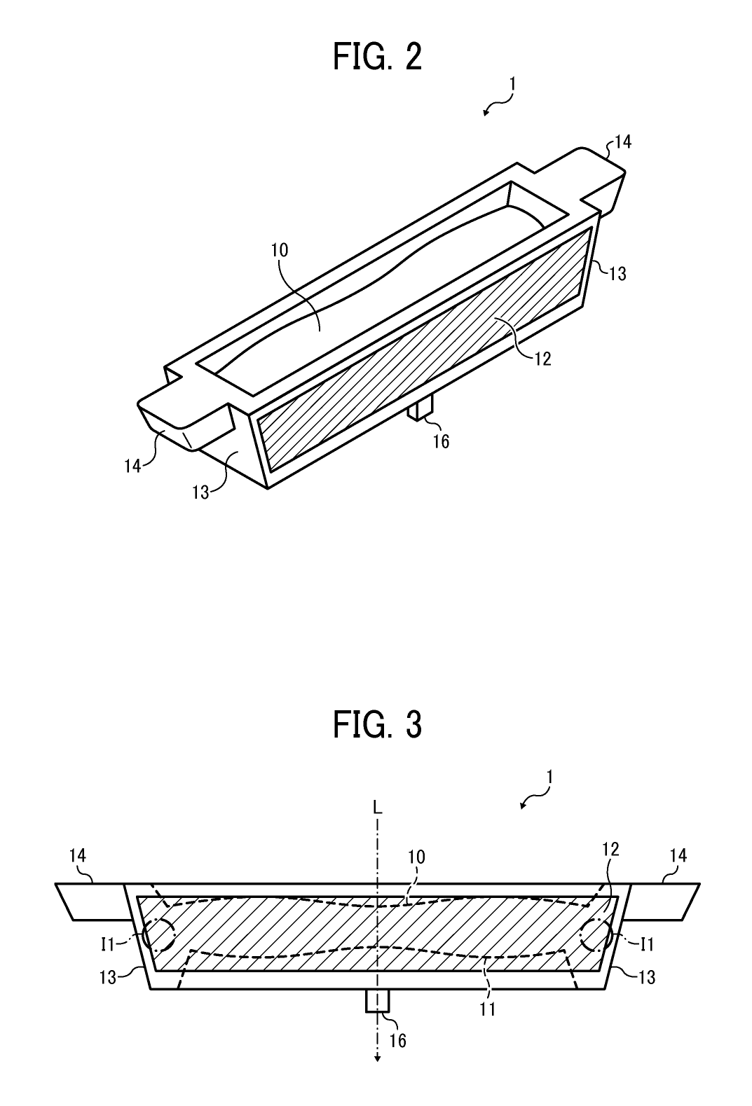

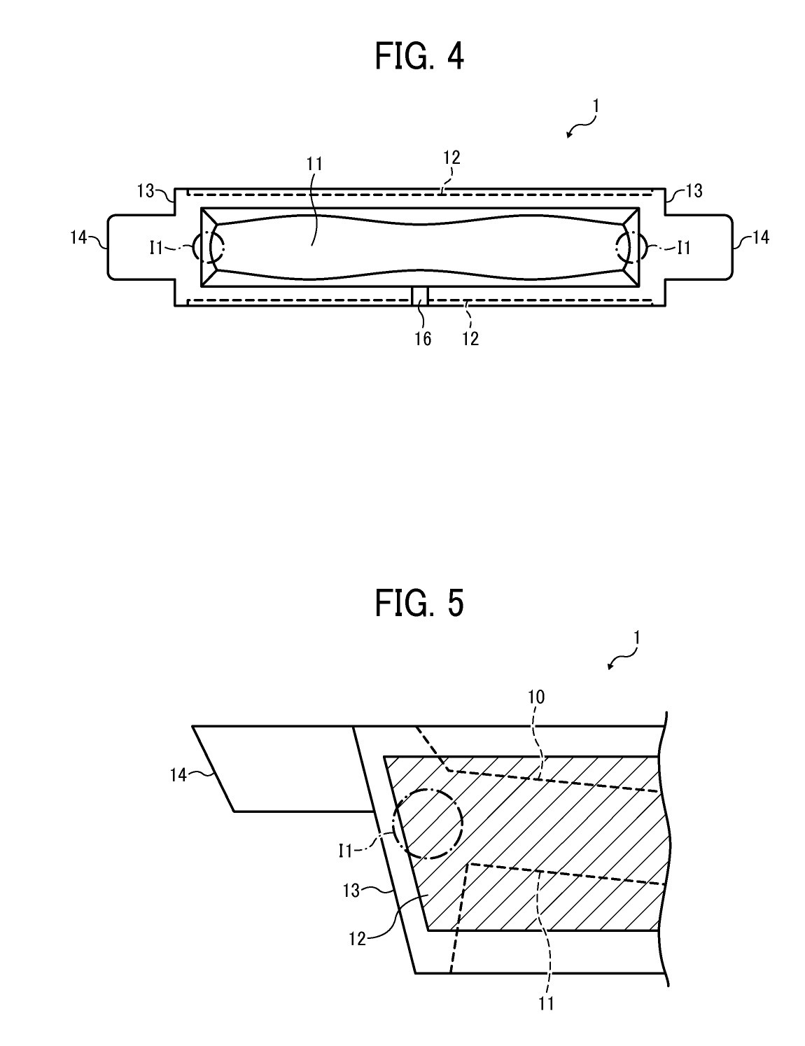

FIG. 2 is a perspective view of an optical component 1 according to the present embodiment. In the present embodiment, the optical component 1 is made of a light-transmitting resin, and serves as a lens having multiple optical surfaces. FIG. 3 is a side view in the longitudinal direction of the optical component 1. FIG. 4 is a rear view of the optical component 1. The optical component 1 includes optical surfaces 10 and 11, non-optical surfaces 12, ribs 13, and attachment portions 14 and 16.

As illustrated in FIG. 3, light L emitted from a light source (not illustrated) is incident on the optical surface 10 and exits from the optical surface 11. In the present embodiment, the optical surfaces 10 and 11 are provided at mutually facing positions.

The non-optical surfaces 12 are provided in longitudinal side surfaces of the optical component 1 to be separated from the optical surfaces 10 and 11. In the present embodiment, portions of the non-optical surfaces 12 are formed by the non-transfer surfaces 32a illustrated in FIG. 1.

The ribs 13 are provided to lateral edge portions of the optical surfaces 10 and 11. The non-optical surfaces 12 and the ribs 13 are disposed to surround and hold the optical surfaces 10 and 11.

The attachment portions 14 are provided at respective positions on the ribs 13 near the optical surface 10. When the optical component 1 is used as attached to an optical scanning device (not illustrated) or the like, the attachment portions 14 serve as base portions connected to the optical scanning device.

The attachment portion 16 is provided at a position not affecting optical properties of the optical surface 11, such as a position outside a longitudinal edge portion of the optical surface 11. When the optical component 1 is used as attached to an optical scanning device (not illustrated) or the like, the attachment portion 16 serves as a base portion connected to the optical scanning device.

The length of the optical component 1 in a direction parallel to the optical surfaces 10 and 11 corresponding to the width b in FIG. 1 is greater than the length of the optical component 1 in a direction perpendicular to the optical surfaces 10 and 11 corresponding to the thickness a in FIG. 1.

FIG. 5 is a partial side view in the longitudinal direction of the optical component 1, enlarging a portion of the optical component 1 near one of the attachment portions 14. As illustrated in FIG. 5, at least a portion of the non-optical surface 12 formed by the non-transfer surface 32a of the injection mold 3 is located closer to the rib 13 than the boundary between the rib 13 and the optical surfaces 10 and 11 formed by the transfer surfaces 30a. In other words, a portion of the non-optical surface 12 is formed in a region including the circle I1 near the intersection of the rib 13 and the optical surfaces 10 and 11.

The thickness of the above-described optical component 1 is maximized in the region including the circle I1. In the injection molding of the optical component 1, therefore, the heat tends to remain in the region including the circle I1, and the cooling and contraction of the resin is most likely to take place in the region.

In the present embodiment, the injection mold 3 including the above-described movable cavity pieces 32 is employed to mold the optical component 1. Therefore, portions of the non-optical surfaces 12 are formed in the regions including the circles I1 by the non-transfer surfaces 32a. As described above, the portions of the non-optical surfaces 12 are formed by retracting the movable cavity pieces 32 during the cooling and contraction of the resin. Accordingly, sink marks of the resin are guided toward the regions including the circles I1 (i.e., non-transfer regions), in which the amount of resin contraction is large, thereby reducing internal stress of the optical component 1.

In the above-described optical component 1, molding failures, such as adhesion of the molded product to the mold, poor release of the molded product from the mold, and warping of the molded product after removal thereof from the mold, are suppressed. Accordingly, external deformation after the molding process hardly occurs in the optical component 1.

Further, in the optical component 1, the contraction of the resin is absorbed in the non-transfer regions. Accordingly, it is possible to highly accurately transfer the optical surfaces 10 and 11 from the injection mold 3 while keeping the pressure of the resin low during the injection of the resin.

Further, the optical component 1 is unlikely to have strain due to residual stress inside the molded product. Therefore, birefringence is unlikely to occur inside the optical component 1 used as a lens. That is, the optical component 1 exhibits favorable optical properties.

Accordingly, the optical component 1 has the shape of the injection mold 3 highly accurately transferred thereto at low cost.

An optical component according to an embodiment of the present invention is not limited to a lens having two optical surfaces, such as the optical component 1 having the two optical surfaces 10 and 11, and is also applicable to a reflecting mirror having a single optical surface vapor-deposited with aluminum or the like to form a reflecting film.

Description will now be given of an injection mold according to another embodiment of the present invention. The following description will focus on differences of the injection mold according to the present embodiment from the injection mold 3 according to the foregoing embodiment.

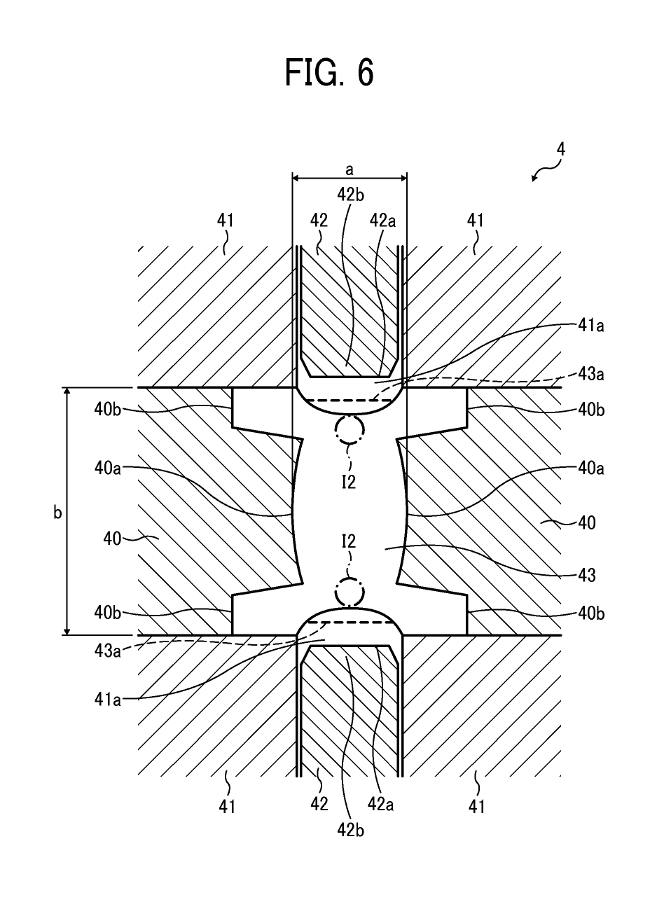

FIG. 6 is a cross-sectional view in the lateral direction of the injection mold according to the present embodiment. An injection mold 4 includes transfer pieces 40, slide pieces 41, and movable cavity pieces 42 that define a cavity 43. Each of the transfer pieces 40 includes a transfer surface 40a and rib forming portions 40b. Each of the slide pieces 41 includes a hole 41a. Each of the movable cavity pieces 42 has a non-transfer surface 42a and a projection 42b. The movable cavity pieces 42 of the injection mold 4 are different in shape from the movable cavity pieces 32 of the injection mold 3 according to the foregoing embodiment.

The non-transfer surface 42a corresponds to a tip surface of the projection 42b. When the resin is injected into the cavity 43, the projection 42b is located at a non-transfer surface stop position 43a, i.e., located farther inside the cavity 43 than a surface of the slide piece 41 facing the cavity 43. Therefore, the volume of the cavity 43 is smaller than that of the cavity 33 according to the foregoing embodiment.

To improve the releasability of the movable cavity piece 42 from the resin when the movable cavity piece 42 is retracted from the cavity 43, the projection 42b has a radially inclined draft angle.

The movable cavity pieces 42 are moved away from the resin during the cooling process of the resin injected in the cavity 43 defined by the transfer surfaces 40a and the non-transfer surfaces 42a, similarly to the movable cavity pieces 32 according to the foregoing embodiment.

Herein, the optical component molded in the injection mold 4 has the thickness a in the beam incidence direction and the width b having the relationship a<b.

Further, at least portions of non-optical surfaces of the optical component formed by the non-transfer surface 42a are located closer to a rib formed by the rib forming portions 40b than the boundary between optical surfaces formed by the transfer surfaces 40a and the rib. In other words, at least portions of the non-optical surfaces are formed in a region including the intersection of the rib and the optical surfaces by the non-transfer surface 42a of the movable cavity piece 42.

In FIG. 6, the position corresponding to the intersection of the rib and the optical surfaces is indicated by a dash-dotted circle 12. Since the thickness of the optical component is maximized at the position of the circle 12, the position of the circle 12 corresponds to the center of resin contraction when the resin injected in the cavity 43 is cooled and contracted.

In the optical component molded in the injection mold 4, the portions of the non-optical surfaces formed by the non-transfer surface 42a of the movable cavity piece 42 including the projection 42b are recessed.

The cooling and contraction of the resin takes place around the circles 12, as described above. Therefore, the contraction of the resin does not affect the optical surfaces formed by the transfer surfaces 40a. That is, in the injection mold 4, the center of resin contraction is guided toward the non-optical surfaces, thereby keeping the center of resin contraction away from the optical surfaces and regions affecting the optical surfaces.

Further, in the injection mold 4, the movable cavity piece 42 includes the projection 42b. Therefore, the distance between the circle 12 indicating the center of resin contraction and the non-transfer surface stop position 43a is shorter than the distance between the circle I1 indicating the center of resin contraction and the non-transfer surface stop position 33a in the injection mold 3. In the optical component molded in the injection mold 4, therefore, the center of resin contraction is located closer to edges of the non-optical surfaces in longitudinal side surfaces of the optical component than in the optical component molded in the injection mold 3.

Further, the injection mold 4 allows the movable cavity piece 42 to penetrate into the cavity 43, thereby reducing the distance between the non-transfer surface stop position 43a and the movable cavity piece 42. Accordingly, the effect of guiding the sink marks toward the non-transfer surfaces is enhanced.

Further, the injection mold 4 increases the contact surface area between the injection mold 4 and the resin by reducing the volume of the optical component to be molded. Accordingly, the resin is effectively cooled. That is, the injection mold 4 reduces the period of time taken to cool the injected resin.

According to the injection mold 4, therefore, the shape thereof is highly accurately transferred to the molded product at low cost.

Description will now be given of an optical component according to another embodiment of the present invention, molded in the above-described injection mold 4. The following description will focus on differences of the optical component according to the present embodiment from the optical component 1 according to the foregoing embodiment.

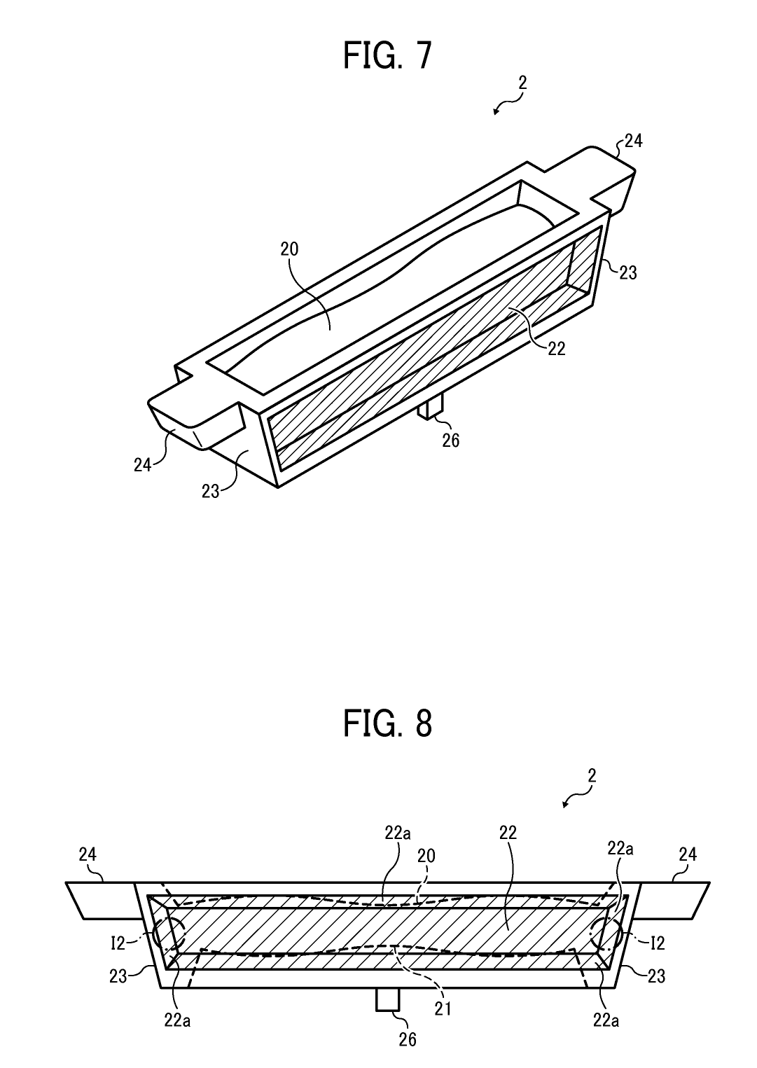

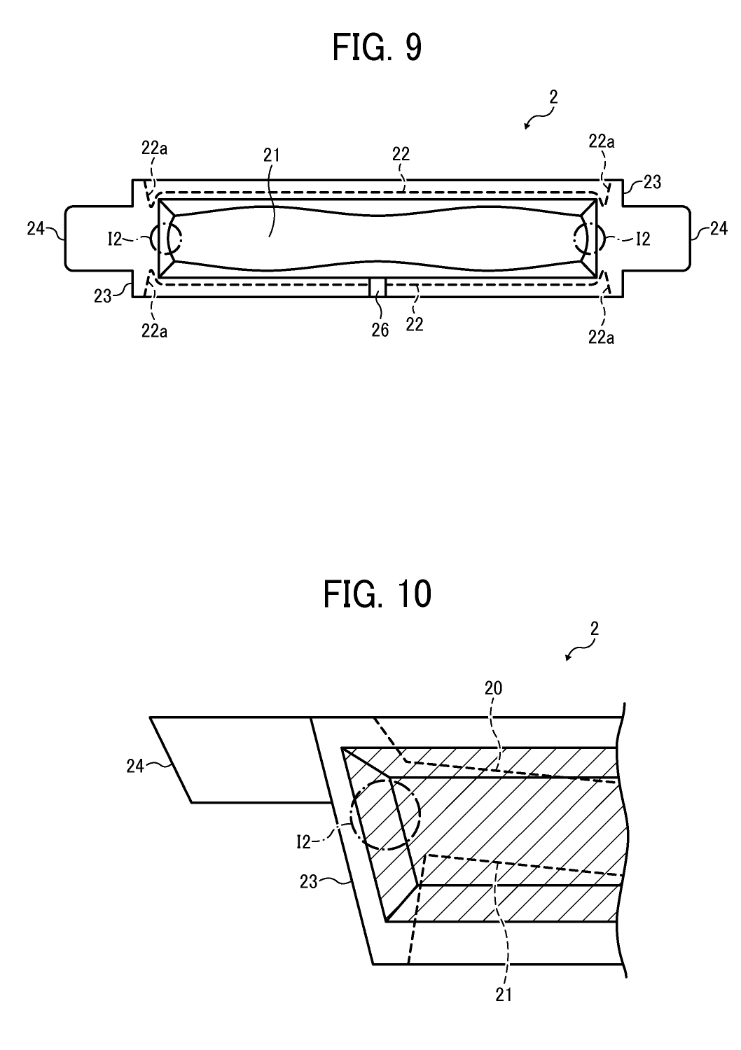

FIG. 7 is a perspective view of an optical component 2 according to the present embodiment. FIG. 8 is a side view in the longitudinal direction of the optical component 2. FIG. 9 is a rear view of the optical component 2. FIG. 10 is a partial side view in the longitudinal direction of the optical component 2, enlarging a portion of the optical component 2 near an attachment portion 24. As illustrated in FIGS. 7 to 10, the optical component 2 includes optical surfaces 20 and 21, non-optical surfaces 22, ribs 23, and attachment portions 24 and 26.

The optical component 2 is different from the optical component 1 according to the foregoing embodiment in that the non-optical surfaces 22 include wall portions 22a, insofar as the wall portions 22a are formed by the projections 42b of the movable cavity pieces 42. In accordance with the shape of the projections 42b of the movable cavity pieces 42, the wail portions 22a inclines from edges to the center of the optical component 2.

As illustrated in FIGS. 8 to 10, at least portions of the non-optical surfaces 22 formed by one of the non-transfer surface 42a of the injection mold 4 is located closer to the corresponding rib 23 than the boundary between the optical surfaces 20 and 21 formed by the transfer surfaces 40a and the rib 23. In other words, the portions of the non-optical surfaces 22 are formed in a region including the circle 12 near the intersection of the rib 23 and the optical surfaces 20 and 21 by the non-transfer surface 42a of the movable cavity piece 42.

In the present embodiment, the injection mold 4 including the above-described movable cavity pieces 42 is employed to mold the optical component 2. Therefore, portions of the non-optical surfaces 22 including the wall portions 22a are formed in the regions including the circles 12 by the non-transfer surfaces 42a corresponding to the tip surfaces of the projections 42b. As described above, the portions of the non-optical surfaces 12 are formed by retracting the movable cavity pieces 42 during the cooling and contraction of the resin. Accordingly, the sink marks of the resin are guided to the regions including the circles 12 (i.e., non-transfer regions), in which the amount of resin contraction is large, thereby reducing internal stress of the optical component 2.

Particularly, in the optical component 2, the circles 12 indicating the center of resin contraction are located near the edges of the optical component 2. In the optical component 2, therefore, the influence of residual stress on the optical surfaces 20 and 21 is less than the influence of residual stress on the optical surfaces 10 and 11 in the optical component 1.

In the above-described optical component 2, molding failures, such as adhesion of the molded product to the mold, poor release of the molded product from the mold, and warp of the molded product after removal thereof from the mold, are suppressed. Accordingly, external deformation after the molding process hardly occurs in the optical component 2.

Further, in the optical component 2, the contraction of the resin is absorbed in the non-transfer regions. Accordingly, it is possible to highly accurately transfer the optical surfaces 20 and 21 from the injection mold 4 while keeping the pressure of the resin low during the injection of the resin.

Further, the optical component 2 is unlikely to have strain due to residual stress inside the molded product. Therefore, birefringence is unlikely to occur inside the optical component 2 used as a lens. That is, the optical component 2 exhibits favorable optical properties.

Accordingly, the optical component 2 has the shape of the injection mold 4 highly accurately transferred thereto at low cost.

An optical scanning device according to an embodiment of the present invention will now be described.

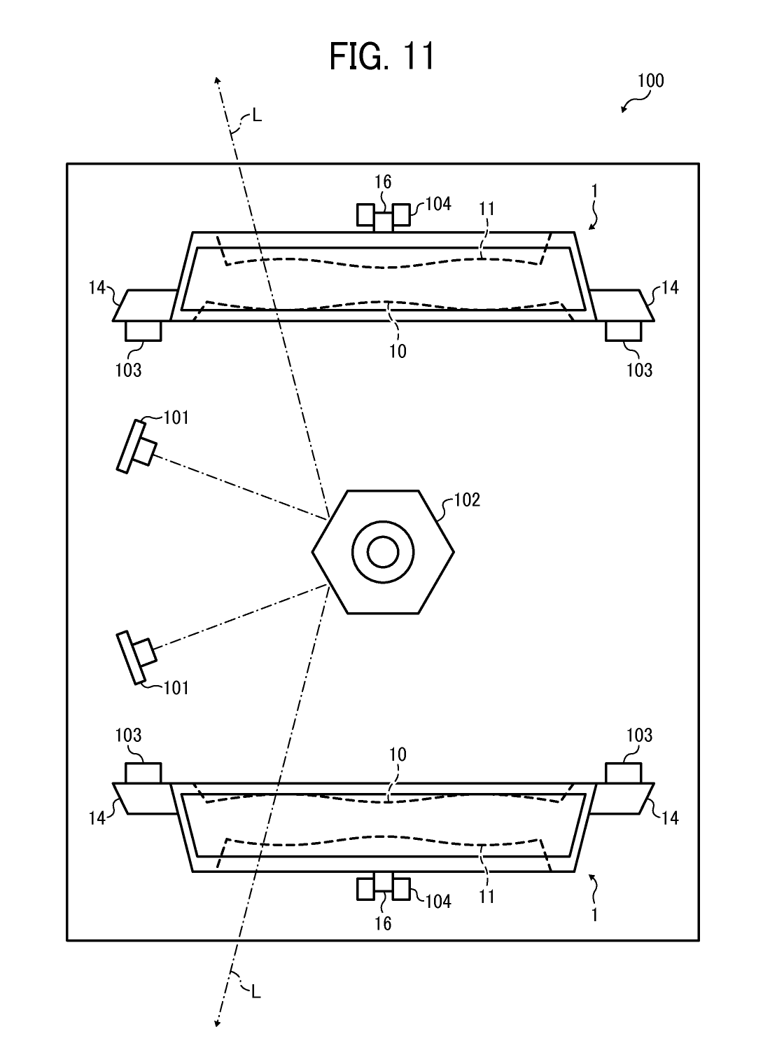

FIG. 11 is a top view of an optical scanning device 100 according to the present embodiment. The optical scanning device 100 includes light sources 101, a rotary mirror 102, attachment portions 103 and 104, and multiple optical components 1 according to the foregoing embodiment, i.e., the lenses made of resin.

The rotary mirror 102 deflects the light L emitted from the light sources 101. The optical components 1 have the attachment portions 14 and 16 attached to the attachment portions 103 and 104 of the optical scanning device 100, respectively, to be fixed to the optical scanning device 100. In each of the optical components 1, the light L emitted from the corresponding light source 101 and deflected by the rotary mirror 102 is incident on the optical surface 10 and emitted from the optical surface 11.

The optical scanning device 100 employs the optical components 1, to which the lens surface shape significantly affecting characteristics of the writing position is highly accurately transferred from the injection mold 3. Accordingly, the optical scanning device 100 is capable of highly accurately controlling the scanning position on an image surface.

Further, the optical scanning device 100 employs the optical components 1, in which birefringence (i.e., internal strain) of the lens affecting the beam diameter is suppressed. Accordingly, the optical scanning device 100 is capable of performing optical scanning on the image surface with a desired beam diameter.

An image forming apparatus according to an embodiment of the present invention will now be described. The image forming apparatus according to the present embodiment includes the optical scanning device 100 according to the above-described embodiment that scans the image surface with the light L emitted from the light sources 101.

With the optical scanning device 100 according to the above-described embodiment, the image forming apparatus according to the present embodiment obtains accurate optical properties such as favorable scanning position and beam spot diameter.

Accordingly, the image forming apparatus according to the present embodiment is capable of writing a latent image with high density and high positional accuracy, and thus forming a high-resolution image with little color shift.

The above-described embodiments and effects thereof are illustrative only and do not limit the present invention. Thus, numerous additional modifications and variations are possible in light of the above teachings. For example, elements or features of different illustrative embodiments herein may be combined with or substituted for each other within the scope of this disclosure and the appended claims. Further, features of components of the embodiments, such as number, position, and shape, are not limited to those of the disclosed embodiments and thus may be set as preferred. It is therefore to be understood that, within the scope of the appended claims, the disclosure of the present invention may be practiced otherwise than as specifically described herein.

What is claimed is:

1. An injection mold for molding an optical component which includes an optical surface, a non-optical surface separated from the optical surface, and a rib provided to an edge portion of the optical surface, and which is longer in a direction parallel to the optical surface than in a direction perpendicular to the optical surface, the injection mold comprising:
a transfer piece including a transfer surface configured to mold the optical surface; and
a movable cavity piece including a non-transfer surface configured to mold at least a portion of the non-optical surface,
wherein the transfer surface and the non-transfer surface define a cavity to be filled with resin, and the movable cavity piece is moved away from the resin during a process of cooling the resin filling the cavity, and
wherein at least a portion of the non-transfer surface is located closer to the rib than a boundary between the transfer surface and the rib.

2. The injection mold according to claim 1, wherein the movable cavity piece is moved in a direction different from a pressing direction of the transfer surface for pressing the resin.

3. The injection mold according to claim 1, wherein the movable cavity piece includes a projection having a tip surface corresponding to the non-transfer surface.

4. The injection mold according to claim 1, wherein the resin transmits light, and
wherein the optical surface is provided at a plurality of mutually facing positions.

5. An optical component that is molded in an injection mold according to claim 1, the optical component comprising:
at least one optical surface;
a non-optical surface separated from the optical surface; and
a rib provided to an edge portion of the optical surface,
wherein the optical component is longer in a direction parallel to the optical surface than in a direction perpendicular to the optical surface.

6. The optical component according to claim 5, wherein the at least one optical surface comprises two optical surfaces.

7. An optical scanning device comprising:
a light source configured to emit light; and
an optical component according to claim 5 configured to perform scanning with the light emitted from the light source.

8. An image forming apparatus comprising an optical scanning device according to claim 7.
